(19) United States
(12) Patent Application Publication
(10) Pub. No.: US 2005/0192811 A1
(43) Pub. Date: Sep. 1, 2005

(54) Portable translation device

(76) Inventors: Wendy Parks, Santa Monica, CA (US); David A. Belasco, Manhattan Beach, CA (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/066,881

(22) Filed: Feb. 25, 2005

Related U.S. Application Data
(60) Provisional application No. 60/548,130, filed on Feb. 26, 2004.

(51) Int. Cl. G10L 11/00

(52) U.S. Cl. 704/277

(57) ABSTRACT

A portable translation device includes a microphone connected to an amplification circuit. A voice recognition module receives input from the amplification circuit and recognizes speech in a plurality of languages from multiple speakers. The voice recognition module converts received speech into printable text. A translation module converts the printable text in a first received language to a second chosen language as printable text. A speaker or headphones are connected to the amplification circuit. An output language selection module identifies a language for voice synthesis. A voice synthesis module converts the printable text generated by the translation module into an electronic signal. The signal is input to the amplification circuit and generates audible speech through either the speaker or headphones. A display screen will display the printable text. A voice learning module assists in voice recognition. An auxiliary input device, such as a keyboard also connects to the portable translation device.

### PRIOR APPLICATION

The instant application claims priority from U.S. Provisional Application Ser. No. 60/548,130 filed Feb. 26, 2004.

### FIELD OF INVENTION

The invention pertains to language translation. More particularly, the invention relates to portable, speech recognition-based systems for providing a variety of translation services using a small, portable device.

### BACKGROUND OF THE INVENTION

The success of any relationship, whether it is business or personal, relies first, upon the accuracy of the communication. This is challenging enough between two people who speak the same language. History and our own life experiences show us that wars, both personal and global have begun with a simple misunderstanding. Add to that, that the two parties speak different languages, and the challenge of effective communication is magnified ten fold. Now factor in that you are relying on a third party (a translator-with their own personal perspectives, prejudices, and limited understandings) to precisely interpret your message, (or your company's message or even your country's message), and your communications difficulties increase by an order of magnitude.

Businessmen, travelers, students and other active people typically cannot afford the luxury or inconvenience of engaging a personal translator for such communications. Toward resolving this problem, a variety of devices have been developed to provide translation services in a more convenient, compact and inexpensive form. These devices include phrase books, language training tapes, and a variety of portable electronic translation devices, most of which require a keyboard entry of words for translation.

The present invention relies on voice recognition hardware and software to provide recognition of spoken language into a printable form. This data is then translated into a desired language, again in printable form. The translated printable language is then output to a screen, printer or storage device or input to a voice synthesis module. The voice synthesis module can output the synthesized sound to headphones or speakers. The system user, upon hearing the translated speech can now speak into a microphone in his native language. The system will then translate his speech into a selected, desired language, in printable form, which may be output to display or storage devices. Alternatively, this output may serve as input to the voice synthesis module and then be output to speakers or headphones. In this way, the system can provide nearly real time translation between parties speaking different languages.

An objective of the present invention is to permit translation of spoken language to printable format. It is a further objective to translate this printable format to one or more different languages in printable form. It is still a further objective to output this translated, printable format to a screen, printer or storage device. It is yet a further objective to use voice synthesis techniques to convert this printable format to a spoken format in the translated language and output this sound to headphones or speakers.

While some of the objectives of the present invention are disclosed in the prior art, none of the inventions found include all of the requirements identified.

### SUMMARY OF THE INVENTION

The present invention addresses all of the deficiencies of prior art translation inventions and satisfies all of the objectives described above.

(1) A portable translation device includes a microphone and an amplification circuit connected to the microphone. A voice recognition module is provided. The voice recognition module receives input from the amplification circuit and recognizes speech in a plurality of languages from multiple speakers. The voice recognition module converts received speech into printable text. A translation module is provided. The translation module converts the printable text in a first received language to a second chosen language as printable text. Either of a speaker and headphones is connected to the amplification circuit. An output language selection module is provided that identifies a language for voice synthesis. A voice synthesis module is provided. The voice synthesis module converts the printable text generated by the translation module into an electronic signal. The signal is input to the amplification circuit and generates audible speech through either of the speaker and headphones.

(2) In a variant of the invention, an input language selection module is provided, identifying a language for voice recognition.

(3) In another variant, a display screen is provided. The display screen illustrates spelling of spoken words and phrases.

(4) In yet another variant, an auxiliary input device is provided. The input device allows input of words and phrases without speech.

(5) In still another variant, a dictionary module is provided.

(6) In a further variant of the invention, a thesaurus module is provided.

(7) In yet a further variant, a telephone module is provided.

(8) In still a further variant, a voice recording module is provided.

(9) In another variant, a data output module is provided. The data output module outputs a digital signal reflecting the printable text.

(10) In a final variant, a voice learning module is provided. The voice learning module allows the translator to better understand individual speakers.

An appreciation of the other aims and objectives of the present invention and an understanding of it may be achieved by referring to the accompanying drawings and the detailed description of a preferred embodiment.

### DESCRIPTION OF THE DRAWING

FIG. 1 is a schematic view of the preferred embodiment of the invention including optional modules for visual display, auxiliary input, input language selection, voice recording, dictionary, thesaurus, telephone connection and voice learning functions.

### DETAILED DESCRIPTION OF THE PREFERRED EMBODIMENT

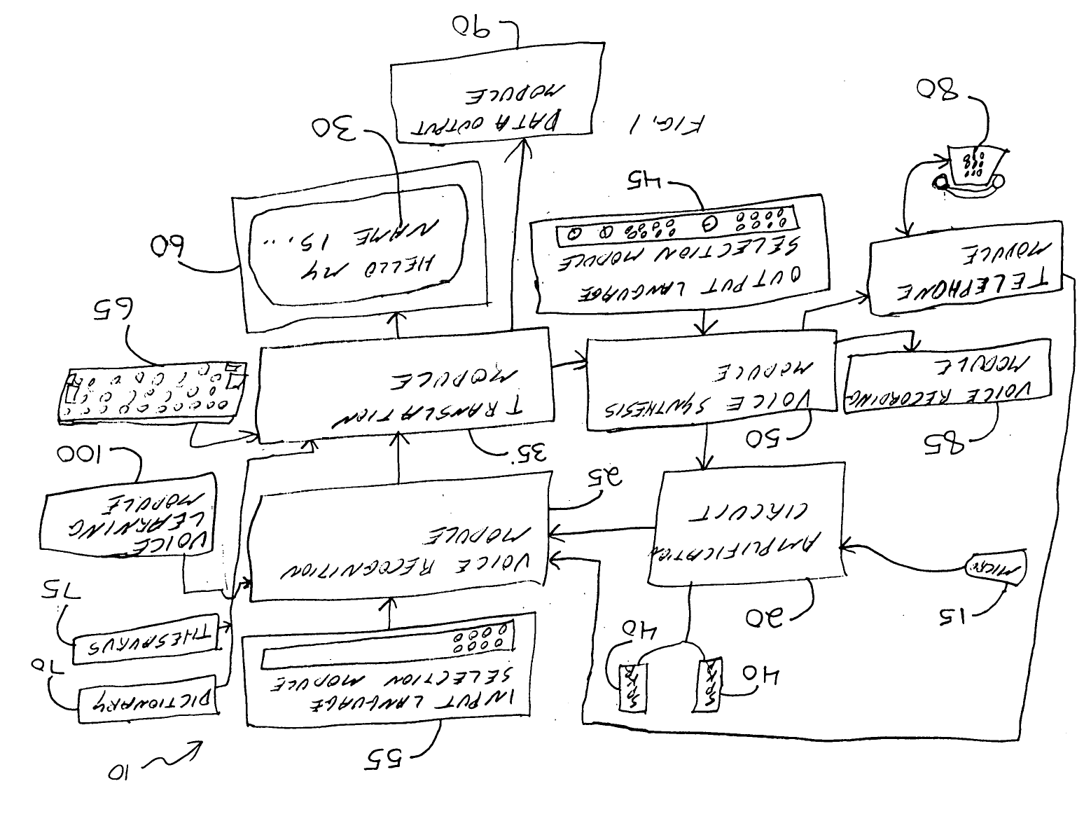

(1) FIG. 1 illustrates a portable translation device 10, that includes a microphone 15 and an amplification circuit 20 connected to the microphone 15. A voice recognition module 25 is provided. The voice recognition module 25 receives input from the amplification circuit 20 and recognizes speech in a plurality of languages from multiple speakers. The voice recognition module 25 converts received speech into printable text 30. A translation module 35 is provided. The translation module 35 converts the printable text 30 in a first received language to a second chosen language as printable text 30. Either of a speaker 40 and headphones (not shown) is connected to the amplification circuit 20. An output language selection module 45 is provided that identifies a language for voice synthesis. A voice synthesis module 50 is provided. The voice synthesis module 50 converts the printable text 30 generated by the translation module 35 into an electronic signal. The signal is input to the amplification circuit 20 and generates audible speech through either of the speaker 40 and headphones.

(2) In a variant of the invention, an input language selection module 55 is provided, identifying a language for voice recognition.

(3) In another variant, a display screen 60 is provided. The display screen 60 illustrates spelling of spoken words and phrases.

(4) In yet another variant, an auxiliary input device 65 is provided. The input device 65 allows input of words and phrases without speech.

(5) In still another variant, a dictionary module is provided 70.

(6) In a further variant of the invention, a thesaurus module 75 is provided.

(7) In yet a further variant, a telephone module 80 is provided.

(8) In still a further variant, a voice recording module 85 is provided.

(9) In another variant, a data output module 90 is provided. The data output module outputs a digital signal reflecting the printable text.

(10) In a final variant, a voice learning module 100 is provided. The voice learning module 100 allows the translator to better understand individual speakers.

The portable translation device 10 has been described with reference to particular embodiments. Other modifications and enhancements can be made without departing from the spirit and scope of the claims that follow.

1. A portable translation device, comprising:
a microphone;
an amplification circuit connected to said microphone;
a voice recognition module, said voice recognition module receiving input from said amplification circuit and recognizing speech in a plurality of languages from multiple speakers;
said voice recognition module converting received speech into printable text;
a translation module, said translation module converting said printable text in a first received language to a second chosen language as printable text;
either of a speaker and headphones, either of said speaker and headphones connected to said amplification circuit;
an output language selection module identifying a language for voice synthesis; and
a voice synthesis module, said voice synthesis module converting said printable text generated by said translation module into an electronic signal, said signal being input to said amplification circuit and generating audible speech through either of said speaker and headphones.

2. A portable translation device, as described in claim 1, further comprising an input language selection module identifying a language for voice recognition.

3. A portable translation device, as described in claim 1, further comprising a display screen, said display screen illustrating spelling of spoken words and phrases.

4. A portable translation device, as described in claim 1, further comprising an auxiliary input device, said input device allowing input of words and phrases without speech.

5. A portable translation device, as described in claim 1, further comprising a dictionary module.

6. A portable translation device, as described in claim 1, further comprising a thesaurus module.

7. A portable translation device, as described in claim 1, further comprising a telephone module.

8. A portable translation device, as described in claim 1, further comprising a voice recording module.

9. A portable translation device, as described in claim 1, further comprising a data output module, said data output module outputting a digital signal reflecting said printable text.

10. A portable translation device, as described in claim 1, further comprising a voice learning module, said voice learning module allowing said translator to better understand individual speakers.
